(19) United States
(12) Patent Application Publication
(10) Pub. No.: US 2008/0038709 A1
(43) Pub. Date: Feb. 14, 2008

(54) APPARATUS FOR DEMONSTRATING COATINGS APPLICATION TECHNIQUES

(76) Inventor: Joseph C. Kowalski, Avon Lake, OH (US)

Correspondence Address: THE GLIDDEN COMPANY, 15885 WEST SPRAGUE ROAD, STRONGVILLE, OH, 44136, US

(21) Appl. No.: 11/738,648

(22) Filed: Apr. 23, 2007

Related U.S. Application Data
(60) Provisional application No. 60/794,862, filed on Apr. 25, 2006.

(51) Int. Cl. G09B 25/00

(52) U.S. Cl. 434/365

(57) ABSTRACT

An apparatus for demonstrating coatings application techniques comprised of a supporting structure or frame having metal, plastic and/or wooden elements that are arranged in a manner to allow for the insertion of at least two vertical working surfaces, which come together at an angle other than 180 degrees to form a working area, which generally forms a geometrical configuration where the working area(s) are either located inside, outside, or inside and outside of the geometrical configuration.

This application claims the benefit including that of priority under 35 U.S.C. 119(e) of U.S. Provisional Patent Application Ser. No. 60/794,862, filed Apr. 25, 2006, entitled “Apparatus for Demonstrating Coatings Application Techniques,” the complete disclosure of which is hereby incorporated by reference.

### FIELD OF THE DISCLOSURE

The present disclosure generally relates to a multi-surface apparatus for demonstrating the application of a variety of coatings by appliers and users of the coatings.

### INTRODUCTION TO THE DISCLOSURE

Recently the nature and scope of specialty finishes for coating or covering substrates has evolved and continues to evolve, increasing the importance of being able to see the affect of the coating after its application. Also if some of these special types of coatings are misapplied the added time and cost for removal can be an important factor in their continued acceptance in the marketplace. Coatings application personnel, like painting contractors, strive to develop and update their application skills to apply these specialty coatings in order to achieve the desired affects as viewed on a large scale with a high degree of consistency. To date, the vast majority of experience that many of these coatings contractors obtain is the direct result of on the job experience, sometimes detracting from the willingness of some contractors to work with certain types of coatings. Training applicators in a relatively short period of time to consistently apply such specialty finishes onto residential, commercial and/or industrial substrates may require hours of moving from job site to job site in order to gain actual experience. This disclosure presents a means whereby this training can be readily achieved by using near life-size areas in order to adequately demonstrate the techniques which need to be employed, as well as to observe the expected results brought about by the application process, while at the same time allowing for a degree of portability. Learning to apply many of the new specialty finishes takes a considerable amount of time and often results in a fair amount of re-work, at least up until the point in time when the contractor has gained the requisite amount of experience to he able to apply these coatings with a high degree of confidence. Not unlike other areas within the construction trade, a major portion of the overall costs are tied up in the labor necessary to undertake the project, versus the actual cost of the coatings. Therefore, in order for a contractor to maximize his profits it's becoming increasingly more important to limit the amount of labor going in to an individual project, and the best way to accomplish that objective is to devise a means of training the coatings contractors to apply these specialty finishes with a high degree of confidence and consistency.

The training of coatings application personnel like professional painters, as well as the ever increasing sector of do-it-yourself painters, has been hindered by the inability to cost-effectively train and/or certify these individuals in the myriad of coating techniques available from the development and evolution of specialty finishes (e.g. faux finishes, crackle finishes, texture finishes, etc.). As the nature and scope of these finishes continues to evolve, it becomes increasingly more important to utilize large scale and/or near life-size areas in order to adequately demonstrate the techniques which need to be employed, as well as to observe the expected results brought about by the application process, while at the same time allowing for a degree of portability.

It would be beneficial to have simulations as learning environments that provide a working substrate and a geometry which can be scaled to mimic near life conditions. Additional benefits can be garnered by allowing for the use of a wide range of substrates (e.g., wood, particle board, drywall, sheetrock, plasterboard, etc.), that provide a plurality of surfaces. These surfaces can have varying styles of trim (e.g., base molding, edging, crown molding, chair rails, door jams, windows, etc.). The arrangement or geometry between adjacent surfaces can be constructed in a manner which better simulates real life conditions.

To date, the inventor has only become aware of one patent which portrays an apparatus for demonstrating painting and/or mural-coating techniques as disclosed in U.S. Pat. No. 6,702,580. This apparatus is a cabinet style enclosure whereby techniques can be learned by using a variety of coatings applicators through a relatively small front opening in the cabinet. The apparatus of the '580 patent has a relatively limited size of the application area, as well as the limitations that this design places on the ability to learn proper application techniques under real-life or near real-life conditions.

With the ever increasing variety of types of finishes that can be applied as a fluid to a substrate to form a coated surface on the substrate, there is still a need for training potential applicators on the proper techniques for improved consistency of results. In particular there is a need for training applicators to achieve a certain level for certification of results from the use of a supplier's fluid coating product. Hence the need arises to train a plurality of potential applicators at each training session where an additional benefit is to have a more mobile training approach for use at a number of locations.

Although the present invention may obviate one or more of the above-mentioned needs, it should be understood that some aspects of the invention might not necessarily obviate one or more of those needs.

### SUMMARY OF THE DISCLOSURE

In the following description, certain aspects and embodiments will become evident. It should be understood that the invention, in its broadest, sense, could be practiced without having one or more features of these aspects and embodiments. It should be understood that these aspects and embodiments are merely illustrative.

In one aspect of the present invention an apparatus is provided for demonstrating a variety of coatings application techniques, where the apparatus has a supporting structure for at least two vertical substrates.

In another aspect of the present invention the supporting structure for the apparatus has at least two longitudinally extending bases that meet in at least one point at other than 180 degrees to each other to form a working area, each base configured to hold at least one vertical substrate.

In a further aspect of the present invention the supporting structure has at least two longitudinally extending top rails that meet in at least one point at other than 180 degrees to each other, and are aligned in a nearly parallel configuration to the bases, each top rail configured to hold at least one vertical substrate.

Another aspect of the present invention can involve the supporting structure also containing at least one vertical support which meets the top rails at one end and the bases at the other end. Such a vertical support can add an additional degree of rigidity to the overall supporting structure, as well as providing support to the vertical working surface during periods of time when the coatings are being applied.

Another aspect of the present invention can involve one or more of the vertical substrates adorned with one or a variety of trim moldings which could include, without limitation, one or more trim moldings such as base molding, crown molding, window molding, door molding, picture molding, corner molding, edge molding, or chair rail. Further enhancements of this or other aspects of the invention can include placement of the trim moldings simulating actual coating environments like those of painting environments, as well as allowing for the use of specialized application techniques in areas which are not generally open and unencumbered.

In another aspect of the present invention the vertical substrates are arranged more suitably to allow for use of both opposing surfaces of the substrates, and the substrates are preferably arranged relative to each other to provide at least six vertical working surfaces and three working stations.

In another aspect of the present invention the concepts being employed in the previous embodiments are being expanded to allow for the creation of additional working areas which can be used by one or more individuals as a means of learning to apply the same coatings under different physical conditions, or for the use of slightly different coatings application techniques required to obtain other finishes.

One or more of the aspects of the present invention overcomes limitations of past training apparatus for application of fluid coating compositions which can also challenge the ability of the coatings contractors by simulating for them near life-size replications of the actual surfaces where the coatings are to be applied. One or more of the embodiments of the present invention can also exhibit a high degree of portability by allowing certain portions of the apparatus to be taken out of the fixed classroom and into the field to be in closer proximity to locations that can be accessed by a larger number of coatings applicators and/or do-it-yourself painters.

### BRIEF DESCRIPTION OF THE DRAWINGS

The accompanying drawings are incorporated in and constitute a part of this specification. The drawings illustrate exemplary embodiments of the invention and, together with the description, serve to explain some of the principles of the invention. In the drawings:

FIG. 1 represents a plan view of a digon configuration which has as many as four vertical working surfaces which can also be described as a simple L-shaped or Y-shaped configuration.

FIG. 2 represents a plan view of a simple geometric configuration which has as many as six vertical working surfaces which can also be described as a simple Y-shaped configuration.

FIG. 3 represents a plan view of an intersecting digon configuration which has as many as eight vertical working surfaces which can also be described as a simple X-shaped configuration.

FIG. 4 represents a plan view of an open trigon configuration which has as many as six vertical working surfaces which can also be described as a simple U-shaped configuration.

FIG. 5 represents a plan view of a trigon configuration which has as many as six vertical working surfaces which can also be described as a simple triangle configuration.

FIG. 6 represents a plan view of a tetragon configuration which has as many as eight vertical working surfaces which can also be described as a simple quadrilateral configuration.

FIG. 7 represents a plan view of a pentagon configuration which has as many as ten vertical working surfaces.

FIG. 8 represents a plan view of a hexagon configuration which has as many as twelve vertical working surfaces.

FIG. 9 represents a plan view of a heptagon configuration which has as many as fourteen vertical working surfaces.

FIG. 10 represents a plan view of an octagon configuration which has as many as sixteen vertical working surfaces.

FIG. 11 represents a plan view of an ennagon configuration which has as many as eighteen vertical working surfaces.

FIG. 12 represents a perspective view of one embodiment, of an apparatus for demonstrating coatings application techniques.

FIG. 13 represents a side view (one such view) of the embodiment depicted in FIG. 12.

FIG. 14 represents a cross-sectional view of one embodiment of a longitudinally extending base or longitudinally extending top rail as shown in FIG. 12.

FIG. 15 represents an exploded view along both axial lines of the embodiment depicted in FIG. 12.

### DETAILED DESCRIPTION OF THE INVENTION

Reference will now be made in detail to exemplary embodiments of the invention, examples of which are illustrated in the accompanying drawings. Wherever possible, the same reference numbers will be used throughout the drawings to refer to the same or like parts. It is to be understood that, both the foregoing general description and the following detailed description are exemplary and explanatory only and are not restrictive of the invention, as claimed.

As used herein, spatial or directional terms such as “longitudinally”, “vertically”, “vertical”, “parallel”, “interior”, “exterior”, “top”, and the like, are understood to encompass various alternative orientations and, accordingly, such terms are not to be considered as limiting.

Also herein, “a”, “an”, “the”, “at least one”, “one or more”, and the like, are used interchangeably.

Also herein, the terms “comprises”, “comprising”, “comprised of” and variations thereof do not have a limiting meaning where these terms appear in the description and claims.

Also herein, all numbers used in the specification and claims are to be understood as being modified in all instances by the term “about”. Accordingly, unless indicated to the contrary, the numerical values used in the specification and claims may vary depending upon the desired properties sought to be obtained by the present invention.

As used herein, he terms “on”, or “adorned with” shall mean provided on but not necessarily in contact with the surface. For example, vertical working surfaces adorned with trim moldings may have the trim moldings affixed to the vertical working surface, or any portion of the supporting structure where it appears that the trim molding might actually be affixed to the vertical working surface.

As used herein the term “vertical substrate” is meant to include a range of similar or dissimilar substrates such as wood, particle board, dry wall, sheetrock, plasterboard, and similar materials which provides a surface on which a coating can be applied and which may be adorned with a variety of trim moldings to make up the “vertical working surface”. A vertical substrate can have either one or opposing vertical working surfaces.

A “vignette” is a device comprised of a metal, plastic and/or wood frame, including a number of cross members, a series of removable substrate surfaces, and a variety of trim pieces which may or may not be added to the frame to depict real life circumstances. In one or more embodiments, the vignette may be in a range of sizes, which includes but is not limited to sizes as small as 1′ by 2′, or as large as 4′ by 8′, possibly even larger. By design, the vignette can contain a variety of similar or dissimilar configurations for use by one or more trainees, or could be configured to allow for the training in multiple application techniques by the same individual.

In an era when a company may be developing a painter certification program, it could be advantageous or beneficial to have a training aid that is flexible enough to be used both in a fixed classroom environment or versatile enough to be used in the field. The vignette can be scaled in size in order to maximize portability, or remain near life size in order provide for a larger application area for the more specialized painting techniques. The vignette, excluding the substrate, can be readily re-packaged and easily transported to another training/certification location.

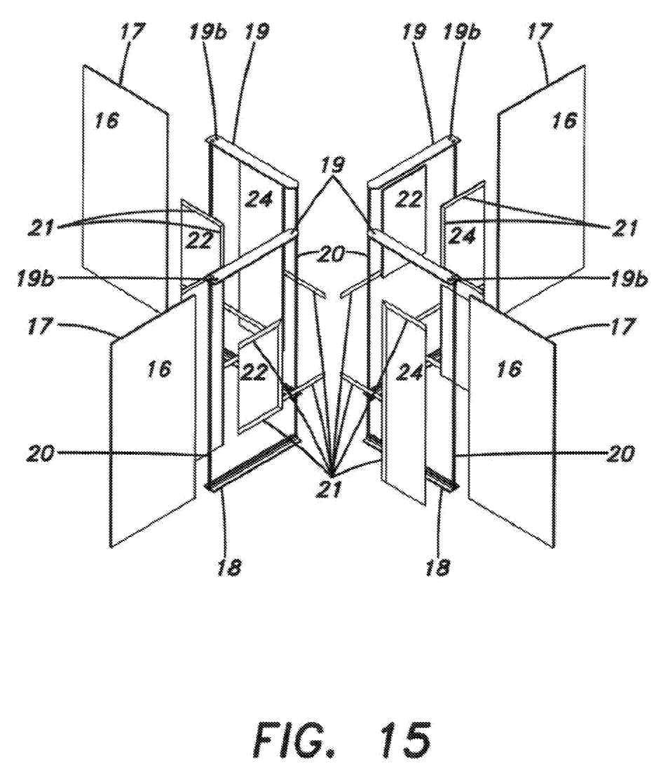

Various possible configurations of the embodiments of the apparatus, as shown individually in FIG. 1 through and including FIG. 15, hereinafter referred to as “Gigs. 1-15” of the present invention are shown in FIGS. 1-11. Generally, all of these embodiments of the present invention provide for more than one vertical substrate, 16, and more than one vertical working surface, 17, and more than one working area, 26.

For instance in the exemplary embodiment of FIG. 1, the apparatus, of the present invention encompasses a digon or L-shaped article. The L-shaped article has two vertical working substrates, 16, where each substrate has at least one vertical working surface, 17. The vertical working services, 17, can be opposing surfaces of the same vertical substrate, 16. In FIG. 1, the L-shaped article has the vertical working surface 17 arranged to form three working areas, each depicted as 26. The vertical working surface, 17, can be the entire surface on one side of the vertical working substrate, 16, or can be any portion of that substrate on one or both sides, 17. As shown in FIG. 1, the vertical working substrates, 16, are arranged with an angular relationship to each other of about 90° to form the L-shaped digon. Of course in the digon one vertical substrate, 16, can have an angular relationship to the adjoining vertical working substrate, 16, that provides a possible working area, 26, between the two adjoining vertical working substrates, 16, for a person. However, if only two working areas, 26, are desired the angle between the two adjoining vertical substrates can be even the smaller. Generally, the range of the angle between the two adjoining vertical working substrates, 16, in a digon can range from about 30° to just under 180°. For the latter situation of just under 180°, the working areas, 26, can provide 4 working areas, 26, and the adjoining vertical substrates, 16, forms more of a straight line (not shown in FIG. 1) than an L-shape.

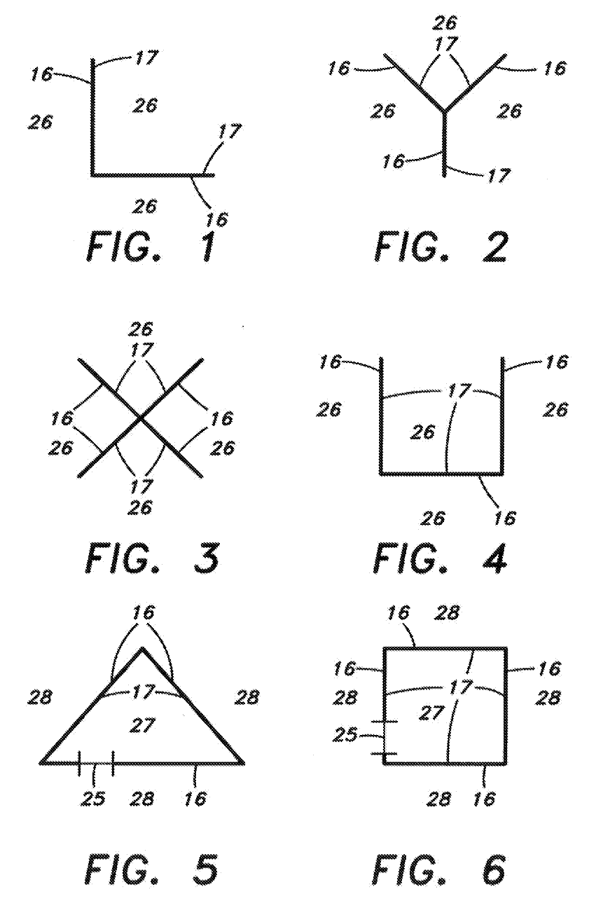

FIG. 2 thru FIG. 4 shows embodiments with open configurations for the article, of the present invention. For instance in FIG. 2 the article of the present invention encompasses a Y-shaped article. The Y-shaped article can have as many as six vertical substrates, 16, such as three sets of opposing vertical substrates (not shown in FIG. 2) where each substrate has at least one exposed vertical working surface, 17. The vertical working surfaces, 17, can be opposing surfaces of the same vertical substrate, 16, or can be on separate and distinct vertical substrates, 16. Also a plurality such as two vertical substrates, 16, can be configured in opposition to one another in a suitable support structure. One non-exclusive example of such a support structure is having the one or two vertical substrates, 16, supported within the longitudinally extending base(s) 18, and longitudinally extending top rail(s) 19, as shown in FIG. 12. As shown in FIG. 2 the vertical substrates, 16, are arranged with an angular relationship to each other of about 120° to form a Y-shaped configuration, however, these angular relationships may change relative to one another. FIG. 2 also incorporates three distinctly separate working areas, 26, but depending upon the angular relationships between the vertical working surfaces, 17, not all of these working areas, 26, need to be actively used at any one time. One beneficial difference between the L-shaped configuration and the Y-shaped configuration is that for the latter each of the three working areas, 26, can have multiple vertical working surfaces, 17, associated with each working area, 26.

The apparatus of the present invention as shown in FIG. 3 encompasses an intersecting digon configuration or X-shaped article. The X-shaped article further expands on the concepts introduced by FIG. 2, but now there are as many as four working areas, 26, instead of just three. Similar to the Y-shaped configuration, the X-shaped configuration can have one or more opposing multiple vertical substrates, 16, and/or vertical working surfaces, 17, for each working area, 26. As with FIG. 1 and FIG. 2 the angular relationship between the adjoining vertical substrates can vary, however, in this instance the degree of variation will be somewhat limited.

The apparatus of the embodiment of the present invention as shown in FIG. 4 is an alternative method of construction of FIG. 2 where this embodiment of the present invention has as many as six vertical working surfaces, 17, arranged in a manner which allows for as many as three working areas, 26. The apparatus of FIG. 4 for the embodiment of the present invention encompasses a U-shaped configuration. One possible advantage that FIG. 4 has over FIG. 2 is that the apparatus can be subdivided into two working areas, 26, each comprised of three similar or dissimilar vertical working surfaces in a configuration which does not overlap one working area, 26, over another. Also, the angular relationships between any two adjoining vertical substrates can be greater than or less than the 90° angle depicted in FIG. 4.

FIG. 5 thru FIG. 11 show embodiments with closed configurations for the apparatus of the present invention. For instance in FIG. 5 the apparatus of one embodiment of the present invention is similar in many respects to that which had been discussed earlier with regard to FIG. 4, except that the U-shape has been transformed into a triangular configuration. Although present somewhat in the embodiment of FIG. 4, the embodiment of FIG. 5 can have one or more external working areas, 28, and optionally can have at least one internal working area, 27. In order to access the internal working area, 27. FIG. 5 shows one or more optional door openings, 25, to allow ingress or egress from the external working area, 28, to the internal working area, 27. Optionally, a window opening (not shown in FIG. 5) can be included in the embodiment of FIG 5. Other aspects for the embodiment FIG. 5 would be similar to that discussed with earlier embodiments. For example, FIG. 5 can have as many as six vertical working areas, 17 (not shown in FIG. 5).

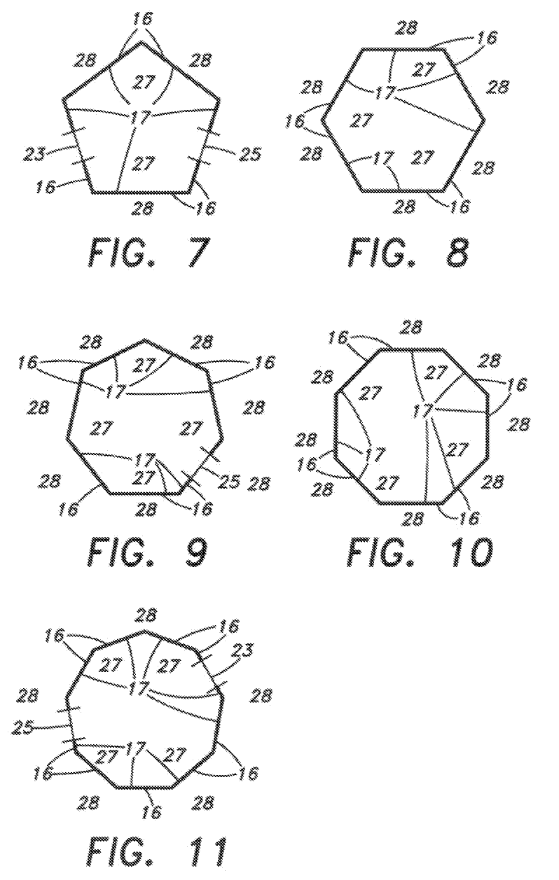

FIG. 6 expands on the concepts discussed with regard to FIG. 5 except that the embodiment of the apparatus in this figure can have as many as eight vertical working surfaces, including the external working area(s), 28, and optionally can have one or more internal working area(s), 27. In order to access the internal working area(s), 27, the apparatus optionally has a door opening, 25, and can have a window opening (not shown in FIG. 6).

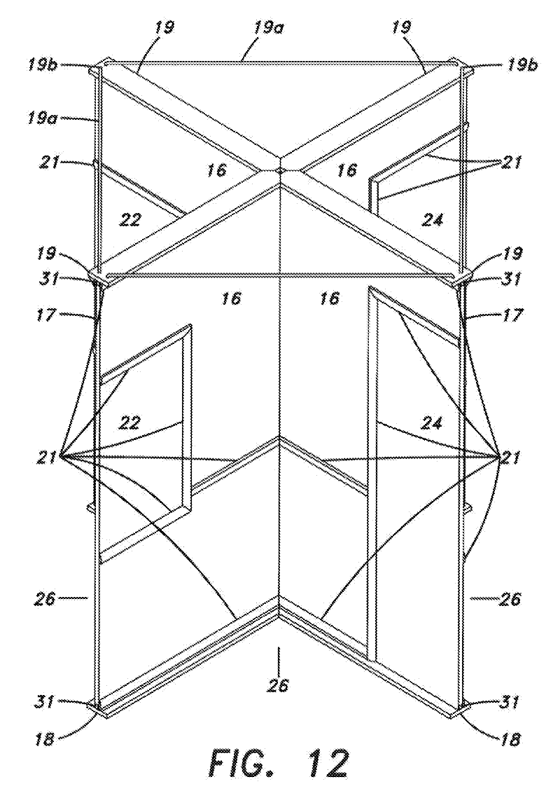

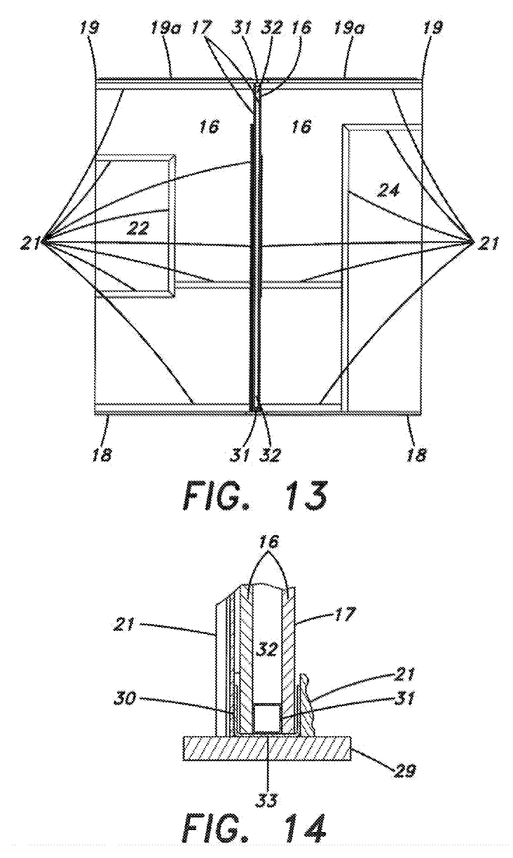

FIG. 7 thru FIG. 11 also expand on the concepts discussed earlier with regard to FIG. 5, but optionally can have one or more door openings, 25, and one or more window openings, 23 (not shown on FIG. 7 thru FIG. 11). While the door opening(s) can allow for ingress or egress between the internal working area(s), 27, and the external working area(s), 28, both the door openings, 25, and the window openings, 23, can have positive effects on ventilation and circulation of air. FIG. 7 shows an embodiment that can have as many as ten vertical working surfaces, 17 (not shown on FIG. 7). FIG. 8 shows an embodiment that can have as many as twelve vertical working surfaces, 17 (not shown on FIG. 8). FIG. 9 shows an embodiment that can have as many as fourteen vertical working surfaces, 17 (not shown on FIG. 9). FIG. 10 shows an embodiment that can have as many as sixteen vertical working surfaces, 17 (not shown on FIG. 10), and that of FIG. 11 can have a shape like an enneagon with as many as eighteen vertical working surfaces, 17 (not shown on FIG. 11).

FIG. 12 thru FIG. 15 depicts a detailed representation of an earlier open type configuration embodiment shown in FIG. 3. FIG. 12 illustrates one of several manners in which the embodiment shown in FIG. 3 can be assembled with a total of eight vertical substrates, 16, in a number of longitudinally extending bases, 18, mounted with four groups of opposing vertical working surfaces, 17, to yield as many as four working areas, 26. In order to add stability and rigidity to the vertical working surfaces, 17, being comprised of four pairs of opposing vertical substrates, 16, and assorted trim moldings, 21, the vertical substrates, 16, are also shown in FIG. 12 as being inserted into longitudinally extending top rails, 19. Optionally, the separation and stability between the longitudinally extending top rails, 19, can be enhanced by the addition of one or more horizontal support rods, 19a, adapted for attachment with horizontal support rod retaining holes, 19b, that have been properly placed in each of the longitudinally extending top rails, 19 (as shown in FIG. 12 but not shown on FIG. 15). The at least one horizontal support rod has a rigidity similar to a longitudinally extending, substantially solid, piece of wood, metal or plastic like polyvinylchloride (“PVC”) or polyalkylene like poly ethylene or polypropylene, or such metal or plastic pipe or tubing with an outer diameter of at least 0.5 inch and an inner diameter of at least 0.13 inch. This rigidity is such that the longitudinally extending rods may deflect from the horizontal when held at one end like that for a 1 inch wide furring strip or a 1 inch wide metal hanging strip when held at one end. As well the plastic rod, pipe or tubing can also deflect from the horizontal to an extent when held at one end. The at least one such support rod is configured around each end of the rod for attachment with at least one and more suitably two horizontal support rod retaining holes that can be placed into each of the longitudinally extending top rails outwardly from where the rails meet. Optionally the support rod or rods are placed closer to the ends of the rails away from where the rails meet. Of course the rod needs not be continuously solid along its entire length but may have additional holes like that in a metal hanging strap to lighten the weight of the rod without sacrificing its supporting capabilities. The attachment with the retaining holes can be with any attachment member known to those skilled in the art such as screws, clips, Velcro, nails, dowels with caps and the like. FIG. 12 also depicts an embodiment which has been adorned with a variety of similar and dissimilar trim moldings, 21. The manner in which the embodiment shown in FIG. 12 represents just one of many examples of how the apparatus of the present invention can be adorned with trim moldings, 21. Because real life situations usually involve the presence of doors, windows, or other similar obstructions, the embodiment shown in FIG. 12 has been shown to include an assortment of doors, 24, and windows, 22. The embodiment shown in FIG. 12 also shows some of the basic elements that comprise the longitudinally extending bases, 18, as well as the longitudinally extending top rails, 19. One of these elements that can be seen in FIG. 12 is the spacer, 31, that is used to hold apart the individual pairs of opposing vertical substrates, 16. The spacer, 31, has been added to this embodiment to depict how the longitudinally extending bases, 18, and the longitudinally extending top rails, 19, have been constructed to accept a variety of vertical substrates, 16, that may or may not have similar cross-sectional dimensions (widths). Similar to the varying widths that can be exhibited by the vertical substrates, 16, this embodiment can be constructed using a variety of spacers, 31, each exhibiting a different width depending upon the width of the vertical substrate, 16, being employed.

FIG. 13 illustrates a typical side view of the embodiment shown in FIG. 12. While FIG. 13 reflects many of the same attributes discussed with respect to FIG. 12, it provides a slightly different special representation of this particular embodiment. Although more clearly depicted in FIG. 12, also depicted in FIG. 13 the embodiment can have a pair of opposing vertical working surfaces, 17, which are being projected out towards the viewer. The cross-sectional representation of these opposing vertical working surfaces, 17, also depict the presence of the spacer, 31 that is present within the longitudinally extending base, 18, as well as the longitudinally extending top rail, 19. The embodiment shown in FIG. 13 also shows the optional horizontal support rods, 19a, that have been added to enhance separation and stability between the longitudinally extending top rails, 19. The embodiment shown in FIG. 13 also shows the presence of a void space, 32, that exists between the two opposing vertical substrates, 16, as they are installed in the longitudinally extending base, 18, and longitudinally extending top rail, 19. Similar to the earlier discussion relative to the spacer, 31, the width of the space, 32, that exists with respect to the embodiment shown in FIG. 13 does not need to remain constant within all possible embodiments. In general, the space, 32, will be the same approximate width on the spacers, 31, being employed to keep apart the vertical substrates, 16, that are mounted in the longitudinally extending bases, 18, and longitudinally extending top rail, 19.

FIG. 14 represents an example of one embodiment of the apparatus of the present invention that was shown in FIG. 12. FIG. 14 is an enlarged cross-sectional representation of either a longitudinally extending base, 18 or and inverted cross-sectional illustration of a longitudinally extending top rail, 19, which shows the insertion of two opposing vertical working surfaces, 17, having been adorned with a variety of trim moldings, 21. FIG. 14 better illustrates the relationship between the different component parts of the longitudinally extending base, 18, or the longitudinally extending top rail, 19. FIG. 14 more clearly depicts the presence of a space, 32, between the opposing vertical working surfaces, 17, as well as the utilization of a spacer, 31, as a means of adding stability and rigidity to the embodiment. FIG. 14 also illustrates the presence of a U-shaped channel, 30, in this embodiment into which the vertical substrates, 16, have been inserted. The U-channel depicted in FIG. 14 is affixed to the base support, 29, by the use of screws, bolts, adhesive, or other similar device, 33. Either or both of the U-shaped channel, 30, or the spacer, 31, can run intermittently or continuously along the longitudinally extending base, 18, and/or top rail, 19. If one or the other is intermittent, the intermittent sections are not too large to cause structural instability in the apparatus of this embodiment of the present invention to impair its use as a portable training apparatus. For instance, the spacer, 31, can be in any number of distinct or connected segments that remain in the channel, 30, to maintain a distance between the opposing vertical substrates, 16. The spacer, 31, can be secured in the channel, 30, by proper physical dimensioning to wedge in between the opposing vertical substrates, 16. Alternatively the spacer, 31, can be secured mechanically by fasteners like nails, screws or clips or by chemical means such as an adhesive or glue. The spacer, 31, can be made of metal or plastic tubing or wood or elastomeric material like rubber. The spacer, 31, is depicted in FIG. 14 with a quadrilateral cross-section but it can also have a round or oval cross-section as for a tube or hose shape. The channel, 30, has opposing vertical sides that have a height sufficient along with dimensions of the spacer, 31, to reduce lateral sliding of the vertical substrates, 16, transverse to the longitudinal axis of the channel, 30, when coating applications are applied to the vertical working surfaces, 17, of the substrates.

FIG. 15 illustrates the manner in which the embodiment depicted previously in FIG. 12 can be assembled. The exploded view along each longitudinal axis of the longitudinally extending bases, 18, away from the vertical center line for all four pairs of opposing vertical substrates in the embodiment shown in FIG. 12 illustrates the relationships between the various pieces that comprise the apparatus of FIG. 15. The exploded view of the embodiment of FIG. 15 illustrates each pair of vertical substrates, 16, separated slightly to highlight each vertical substrate, 16, in each pair. FIG. 15 also depicts the presence and locations of the vertically extending supports, 20, that were used in the embodiment shown in FIG. 12. The vertically extending supports, 20, aid in the stability and rigidity for the apparatus of FIG. 15.

The embodiment of the apparatus of the present invention depicted in the embodiment represented by FIG. 12 can be used, for example, as either a classroom training tool to allow professional painters and/or amateur do-it-yourself painters the opportunity to experience what it would be like under real life conditions to apply one or more specialized coatings, and view the results. The use in this environment provides an educational or learning experience in a setting where the applicator can ask questions and/or receive classroom-type instruction. The apparatus of this embodiment as well as most of the other depicted embodiments allows for either multiple learning experiences by the same applicator, or it allows for similar consecutive or simultaneous training experience by a plurality of different applicators, all in the same learning environment.

Further, to support the growing need for demonstrating and/or learning the specialized coatings application techniques by a large and diverse population of professional and amateur applicators alike, the embodiment depicted in FIG. 12, as further illustrated by FIG. 15, can lend itself to being readily portable, meaning that it can be easily transported between one field location and another. Those portions of the apparatus which can be considered as being readily disposable include one or more of the vertical substrates, 16, the trim moldings, 21, as well as the window, 22 and door, 24, panels. These parts can be replaced easily by obtaining fresh materials from the local outlets that sell building materials. In essence, the portions of the embodiment illustrated by FIG. 15 that are readily portable include the longitudinally extending bases, 18, the longitudinally extending top rails, 19, the vertically extending supports, 20, and any pieces of trim molding, 21, that appear to be reusable. The ability of the embodiment depicted in FIG. 12 and FIG. 15 to be both versatile and portable which allow the apparatus to become a very effective training device for a wide variety of coatings applications.

In use the erected training device of the embodiment of FIG. 12 can have a person present at each of the four working areas, 26, where said person(s) can apply one or more coating applications to a vertical working surface, 17. Because the embodiment depicted in FIG. 12 has as many as eight vertical working surfaces, 17, each person can then apply a similar or dissimilar coating to an adjacent vertical working surface, 17, while still being resident within the same working area, 26. Once the applications have been applied, the vertical substrates, 16, can either be re-coated with a primer coating or other similar coatings application, and then re-used in subsequent training sessions as fresh vertical working surfaces, 17. Alternatively the vertical substrates, 16, can be removed from the apparatus of the present invention properly disposed of, and replaced with new vertical substrates, 16, for use in the next subsequent training session. At the conclusion of the training session(s), the vertical working surfaces, 17, including the vertical substrate, 16, and any expended trim molding, 21, can be removed from the supporting structure and may be disposed or used for another similar purpose. In general, depending upon the location of the next subsequent training session, the only components that will need to be shipped from one location to another are those elements that make up the supporting structure, the longitudinally extending bases, 18, the longitudinally extending top rails, 19, the vertical supports, 20, and any of the trim moldings, 21, than can be re-used. The remaining elements such as the vertical substrates, 16, and additional trim moldings, 21, can be obtained locally from a building materials supply center to form or erect or construct the apparatus as a training device for another training session.

What is claimed is:

1) An apparatus for demonstrating coatings application techniques, comprising:
a supporting structure with at least two longitudinally extending bases that meet in at least one point at other than 180 degrees to each other to form a working area, each base configured to hold at least one vertical substrate, the surface of which comprises the vertical working surface;
at least two vertical working surfaces where at least one vertical substrate is held in place by each base.

2) The apparatus of claim 1 wherein the coating application technique is for painting which is applied to at least a portion of at least one vertical working surface.

3) The apparatus of claim 2 wherein the painting application technique is for an antique finish, candle light finish, combed finish, crackle finish, faux finish, glazed finish, marbleized finish, reflective finish, stippled finish, textured finish, tortoise-shell finish, whitewash finish, water-based paints or solvent-borne paints.

4) The apparatus of claim 2 wherein painting is accomplished by brushing, combing, dabbing, glazing, ragging, rolling, rubbing, spattering, splattering, spraying, sponging or streaking.

5) The apparatus of claim 1 wherein the plurality of bases form a geometric configuration ranging from a simple L-shape as shown in FIG. 1 to an enneagon as shown in FIG. 11.

6) The apparatus of claim 1 further includes at least one vertically extending support which extends from said base for support of at least one vertical substrate.

7) The apparatus of claim 6 includes vertically extending supports at the end of each of said bases and at each point where said bases meet.

8) The apparatus of claim 6 optionally includes at least two longitudinally extending top rails that meet in at least one point at other than 180 degrees to each other and are generally parallel to the bases where they adjoin to the vertically extending supports and vertical substrates.

9) The apparatus of claim 8 wherein the separation and stability between two or more longitudinally extending top rails is enhanced by the addition of at least one rigid horizontal support rod each configured around each end of the rod for attachment with at least one horizontal support rod retaining holes that can be placed into each of the longitudinally extending top rails outwardly from where the rails meet.

10) The apparatus of claim 8 wherein the longitudinally extending bases, vertically extending supports, and longitudinally extending top rails are made from metal, wood, plastic, or a composite material, and the vertical substrates are composed of drywall, wood, or other composite material onto the surface of which the coating is to be applied.

11) The apparatus of claim 8 wherein the longitudinally extending bases, the vertical extending supports, and the longitudinally extending top rails are constructed in a manner and shape which will allow them to support and hold the vertical substrates in place during the process of demonstrating the coating application technique.

12) The apparatus of claim 7 wherein the longitudinally extending bases and the vertical extending supports are each configured to allow for the insertion of two vertical substrates opposing each other in each base.

13) The apparatus of claim 1 wherein at least one vertical substrate is adorned with at least one variety of trim molding selected from base molding, chair rail, corner molding, crown molding, door molding, edge molding, picture molding, window molding, or any combination thereof.

14) The apparatus of claim 13 wherein a plurality of moldings are configured to form a doorway on at least one vertical working surface, where optionally the area surrounded by the door molding may be an opening in the vertical working surface.

15) The apparatus of claim 14 where the opening in the vertical working surface allows for ingress and egress between an external working area and an internal working area.

16) The apparatus of claim 1 is constructed in a manner which contributes towards its ease of portability, for use as a field training device.

17) A portable apparatus for demonstrating coatings application techniques, comprising:
a supporting structure with at least two longitudinally extending bases configured to meet in at least one point at other than 180 degrees to each other to form at least one working area, each base configured to hold at least one vertical working surface,
at least two vertical working surfaces where at least one vertical working surface is held by each base,
where the geometrical configuration of the longitudinally extending bases is that of a L-shape; a Y-shape, a X-shape, a U-shape; a 3-sided polygon; a 4-sided polygon, a 5-sided polygon, a 6-sided polygon, a 8-sided polygon, or a 9-sided polygon,
where the coating application technique is for painting which is applied to at least one vertical working surface;
where the method of painting is selected from brushing, dabbing, ragging, rolling, rubbing, spattering, spraying, or sponging;
at least one vertical extending support which extends upward from said base for support of at least one vertical working surface,
at least two longitudinally extending top rails that meet and come together in at least one point at other than 180 degrees to each other and are generally parallel over the bases,
where separation and stability of the vertical working surfaces is enhanced by the addition of at least one horizontal support rod each configured around each end of the rod for attachment with at least one horizontal support rod retaining hole that can be placed into each of the longitudinally extending top rails outwardly from where the rails meet towards the ends of each longitudinally extending top rail,
where the longitudinally extending bases, vertical extending support, horizontal support rods, and longitudinally extending top rails are made from wood, metal, plastic, or other composite material,
where the vertical working surfaces are composed of drywall, wood or other composite material onto which the coating is to be applied,
where at least one vertical working surface is adorned with at least one variety of trim molding selected from base molding, chair rail, corner molding, crown molding, door molding, edge molding, picture molding or window molding, and
where the apparatus is constructed in a manner which contributes towards its ease of portability, for use as a field training device.

18) The portable apparatus of claim 17, wherein the supporting structure with at least two longitudinally extending bases configured to meet in at least one point at other than 180 degrees to each other to form at least one working area, each base configured to hold at least one vertical working surface.

19) The portable apparatus of claim 18, wherein the supporting structure of the longitudinally extending bases, 18, the longitudinally extending top rails, 19, the vertical supports, 20, and any of the trim moldings, 21, are capable of re-use and are shippable from site to site and where at least one different vertical working surface is combined with the re-used supporting structure at each site.

20) A method of re-using a portable apparatus for demonstrating coatings application techniques, comprising:
erecting a supporting structure with at least two longitudinally extending bases that meet in at least one point at other than 180 degrees to each other to form a working area, each base configured to hold at least one disposable vertical working substrate, the surface of which comprises the vertical working surface with at least two vertical working surfaces where at least one vertical substrate is held in place be each base to form a training device for demonstrating coatings application techniques;
applying at least one coating application to a vertical working surface;
removing at least one vertical working substrate with coated vertical working surface from the supporting structure;
shipping the supporting structure to another location;
replacing the removed vertical working substrates with different vertical substrates in the supporting structure to form the training device.
